(19) United States
(12) Patent Application Publication
(10) Pub. No.: US 2012/0250345 A1
(43) Pub. Date: Oct. 4, 2012

(54) LIGHTING UNIT HAVING LIGHT GUIDE(S) INSERTED BEWTEEN A REFLECTOR AND A SCREEN

(75) Inventors: Rodolphe Peron, Herblay (FR); Gilles Moynier, Sarge Les Le Mans (FR)

(73) Assignee: PEUGEOT CITROEN AUTOMOBILES SA, Velizy Villacoublay (FR)

(21) Appl. No.: 13/510,051

(22) PCT Filed: Nov. 24, 2010
(86) PCT No.: PCT/FR2010/052517

§ 371 Date: Jun. 13, 2012

(30) Foreign Application Priority Data
Nov. 27, 2009 (FR) 0958455

(51) Int. Cl. G02B 6/00

(52) U.S. Cl. 362/555; 362/551

(57) ABSTRACT

The invention relates to a dedicated lighting unit (D) which includes: i) at least one light guide (GL) comprising two opposing ends, at least one of which is coupled with a light source (SL); ii) a reflector (RL) having at least one concave section and intended for being placed opposite a rear portion of the light guide (GL) in order to reflect the guided light from the light source (SL) towards a front portion (PV) of the light guide (GL); and iii) a screen (EC) having at least one transparent central portion (PC) intended for being placed opposite at least one portion of the front portion (PV) of the light guide (GL) in order to be illuminated by the light transferred towards the outside and thus to induce a style effect and/or a three-dimensional effect.

The invention relates to lighting devices comprising light guides, and in particular those used in vehicles, in particular automotive type vehicles.

In certain domains, like for instance in optical blocks of automobiles, light guides are used to form luminous bars. These light guides are supplied with light, at least at one of their opposite ends, by light sources such as light emitting diodes (or LEDs). The light propagates through the interior of the light guide and is transferred to the exterior through its (lateral) external face.

The use of a planar light guide allows for the creation of lighting devices of relatively large dimensions, but prohibits style effects and/or three dimensional effects (such as for instance a volume or depth effect).

With tubular light guides some style effects can be obtained, but they are prohibitive for creating lighting devices of average or large dimensions (the diameter is typically limited to approximately 1 cm) because of light homogeneity issues. Furthermore, when a light guide is used in an optical block, it is in essence the light that it is transferring from the front portion of its external face (oriented towards the interface glass of the optical block) which effectively serves for lighting, which does not offer good efficiency. To remedy this inconvenient, it was proposed, specifically in patent documents FR 2850731, EP 1036979 and US 2006/01 93144, to place opposite the rear part of the external face of the light guide a reflector intended to reflect the light towards the internal part of this light guide, and as much as possible towards its front part. This solution improves in particular the lighting efficiency, but, it does not allow for obtaining various style effects, nor real three dimensional effects.

The goal of the invention is therefore to propose an alternative solution which improves the situation.

For this purpose, the invention is proposing a lighting device comprising at least a light guide which includes two opposite extremities, of which at least one is coupled to a light source, and a reflector which has at least a concave section and which is intended to be placed opposite the rear part of the light guide to reflect towards the front part of the light guide the guided light emitted by the light source.

This lighting device is characterized by the fact that it comprises furthermore a screen with at least one transparent central portion and intended to be placed opposite a part at least of the front part of the light guide in order to be illuminated by the light that it transfers towards the exterior, inducing in this manner a style effect and/or a three dimensional effect.

The lighting device according to the invention can comprise other characteristics which can be included separately or in combination, and in particular:
the rear part of each light guide can be housed in a compartment comprising its reflector in a zone with concave section;
each central part of the screen can be grooved or grained or sanded or polished;
its screen can have a concave section defined by a central part and two lateral parts, situated on both sides of this central part, in order to reinforce the three dimensional effect and/or the style effect;
   The lateral parts can be transparent and grooved, or transparent and grained, or transparent and sanded, or transparent and polished, or metalized;
its screen can have a section with variable form between its two opposite ends;
   the screen section can have an increasing flaring;
the rear part of each light guide can comprise a flat portion;
   the flat portion can be provided with a relief arranged in such manner as to promote the reflection of light towards the front part of its light guide;
the relief can consist of grooves approximately parallel to each other and approximately perpendicular to the general direction of the light guide;
   the grooves can have a triangular shape;
each light source can comprise at least one light emitting diode;
its reflector can comprise at least two concave sections which are intended to be placed respectively opposite the rear parts of the corresponding light guides, and its screen can comprise at least two central parts intended to be placed respectively opposite the front parts of these corresponding light guides;
each light guide and/or its reflector and/or its screen can be constructed in polycarbonate (or PC);
its reflector can comprise a metalized internal face.

The invention is also proposing an optical block comprising at least a lighting device of the type presented above.

The invention can for instance be used in the domain of vehicles, in particular automotive type vehicles.

Other characteristics and advantages of the invention will become clear by examining the following detailed description, and the attached drawings (obtained for the most part in CAO/DAO), in which:

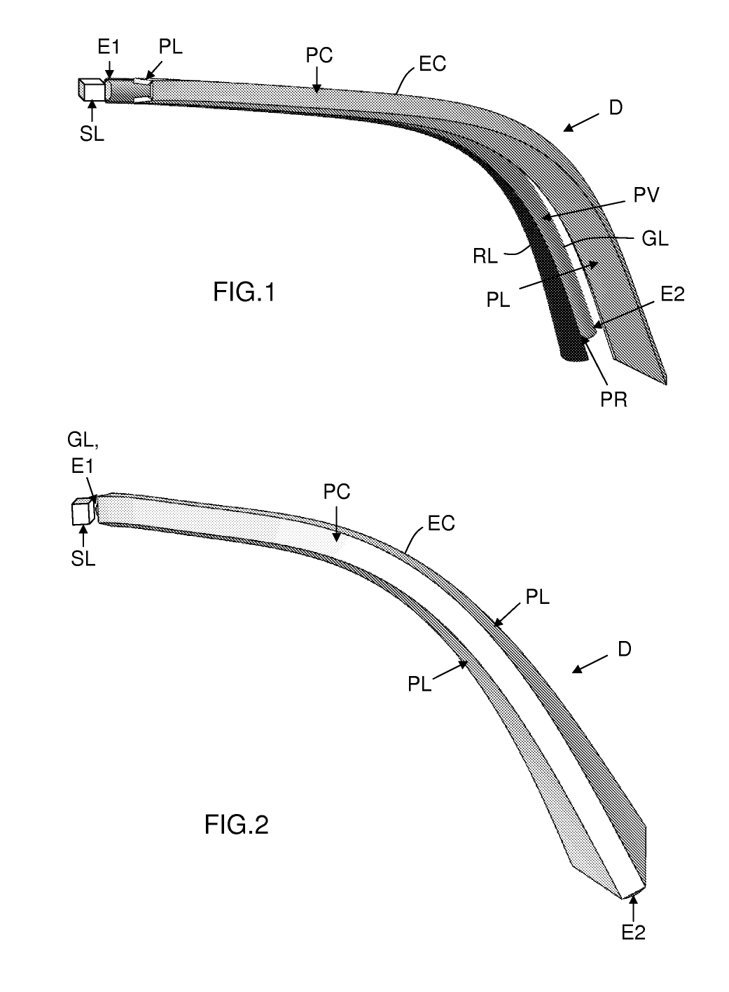

FIG. 1 illustrates schematically, in perspective view, a first implementation example of a lighting device according to the invention, prior to assembly,

FIG. 2 illustrates schematically, in perspective view (from below), the lighting device of FIG. 1 after assembly,

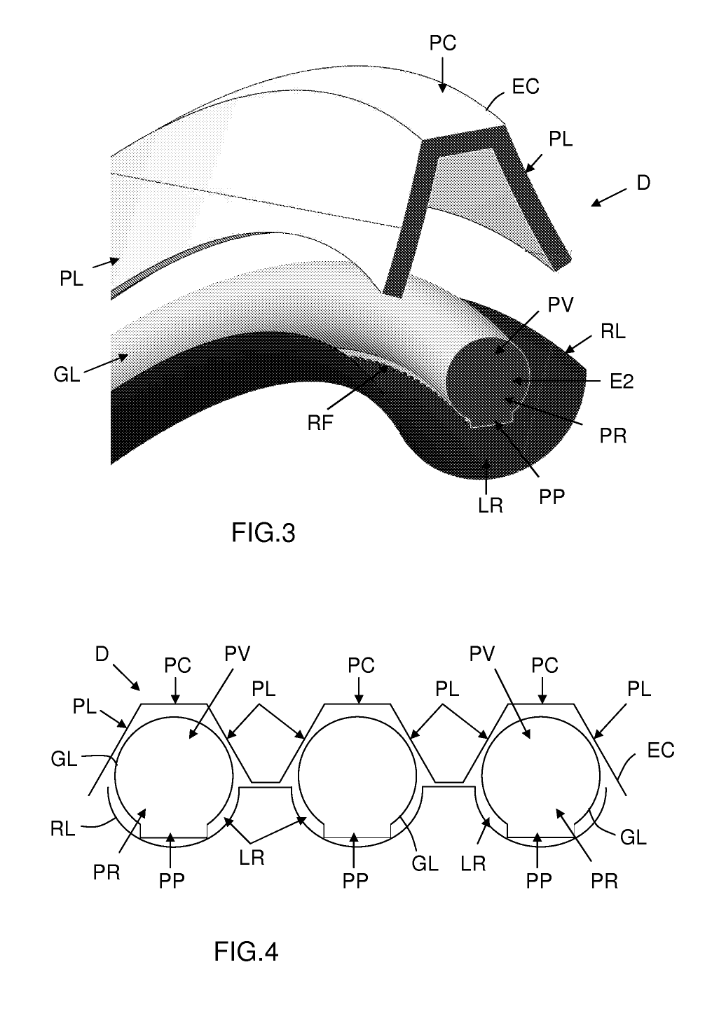

FIG. 3 illustrates schematically, in perspective view, one of the two extremities of the lighting device of FIG. 1, prior to assembly, and

FIG. 4 illustrates schematically, in a transversal section, a second example of an implementation mode of a lighting device according to the invention.

The attached drawings serve not only to complete the invention, but also to contribute to its definition where required.

The goal of the invention is to provide a lighting device (D) with light guides (GL), which allows for numerous luminous style effects and/or three dimensional effects (or 3D).

In the following, it is assumed as a non-limiting example, that the lighting device (D) is intended to be part of an optical block (not shown) of a vehicle, in particular an automotive type vehicle. But, the invention is not limited to this application. A lighting device (D), according to the invention, can equip any type of system, equipment or device, including the internal or external walls of buildings (in particular by providing additional sealing means to protect the electronics).

To be noted that the optical block could be a head lamp (or front projectors), or a tail lamp (rear).

Reference is made first to FIGS. 1 to 3 representing a first implementation mode example of the lighting device D according to the invention.

As illustrated, a lighting device D according to the invention, comprises at least a light guide GL, at least a light source SL, a reflector RL and a screen EC.

In the non-limiting example illustrated in FIGS. 1 to 3, the (lighting) device D comprises only one light guide GL. But, it could comprise several, at least two, as is the case in the second implementation example illustrated in FIG. 4 (which has three).

Each light guide GL comprises two extremities E1 and E2 opposite to each other and of which at least one is connected to a light source SL.

In the non-limiting example illustrated in FIGS. 1 and 2, only the first E1 of the two extremities of the light guide GL is coupled to a light source SL. But it can be envisaged that the two extremities E1 and E2 are each coupled to a light source SL in order to reinforce the homogeneity and/or the intensity of the illumination, and/or to create a style effect.

It is understood that the light, generated by a light source SL, penetrates through an end face of the light guide GL, which is here situated at its first extremity E1, and propagates through the interior (in other words through the mass).

Each light source can comprise at least one light emitting diode (or LED) of which one light emitting extremity is placed against one end face of the first extremity E1 of the light guide GL, which was selected for light injection.

When using light emitting diodes SL, it is advantageous that they are mounted on a support plate intended to allow at least for their control and electrical supply. This support plate can be for instance a printed circuit board, PCB type (“Printed Circuit Board”), rigid or flexible (“Flex type”).

Each light emitting diode SL can be coupled to a light guide GL either directly, for instance by gluing or by insertion in an orifice defined in its injection end face, or indirectly, for instance via the support plate.

Each light emitting diode SL can be arranged in such manner as to emit white or colored light. In the presence of at least two light emitting diodes SL, these diodes can be arranged in such manner as to emit light of different or identical color.

In the non-limiting examples illustrated in FIGS. 1 to 4, each light guide GL has in general a circular section. But this is not mandatory. This section can be rectangular or square or pentagonal or hexagonal, for instance.

In the non-limiting example illustrated in FIGS. 1 to 3, each light guide GL has at least one curvature. But, each light guide GL could have several curvatures (at least two), in particular in different planes, or none (purely rectilinear case). To be noted that in the presence of several light guides GL, these light guides (GL) can have different shapes (and therefore different curvatures).

To be noted also, as illustrated in non-limiting manner in FIGS. 3 and 4 that the rear part PR of each light guide GL can comprise a flat portion PP intended to favor the reflection of light towards the front part PV. As illustrated in non-limiting manner in FIG. 3, this flat portion PP portion can be equipped advantageously with a relief RF arranged in such manner as to favor even more the reflection of light towards the front part PV.

By “rear part PR” is understood here the part of a light guide GL of which the external face (perpendicular to an end face) is oriented towards reflector RL, and by “front part PV” the part of a light guide GL of which the external face is oriented towards screen EC.

The relief RF is intended to optimize the transfer, on the one hand, of the light reflected by the reflector RL towards the front part PV of a light guide GL, and on the other hand, of the light which propagates at the interior of this light guide GL.

By “transfer of light” is understood here a deviation provoked by a reflection or a refraction, even a diffraction, at the material-air or air-material interface, and therefore at the level of the relief RF (internal or external side).

The relief RF can be constituted, for instance, of grooves (or ribs, which is the same) which are, on the one hand, parallel to each other (and therefore perpendicular to the general direction of a light guide GL). It is important to note that due to eventual curvatures of the light guide GL, the grooves (or ribs) RF may not be locally parallel to each other (in particular in the curvature zones). The parallelism is understood here as a general trend.

For instance, the grooves (or ribs) RF can have a section with triangular shape (eventually isosceles), or more generally with saw tooth profile.

To be noted that the relief RF is not mandatorily constituted of lines (grooves or ribs or serrations). It can be constituted of three dimensional motives (3D), in particular diffracting motives, or arranged in the form of a diffraction grid.

Each light guide GL can be constructed, for instance, by moulding in synthetic material, for instance in PC (polycarbonate) or in PMMA. Each light guide GL can be colored in the mass.

The reflector RL has at least one concave section and is intended to be placed opposite a rear part PR of each light guide GL in order to reflect towards a front part PV of the light guide GL of the guided light emitted from each source of light SL to which it is coupled.

To be noted, as illustrated in non-limiting manner in FIGS. 1 to 4 that the rear part PR of each light guide GL can be housed inside a compartment LR which comprises reflector RL in a zone with concave section. This compartment does not necessarily imply that the outside face of the rear part PR of each light guide GL is partially or totally in contact with the internal face that delimits the compartment LR of reflector RL. Indeed, it can be envisaged that a light guide GL is at a slight distance from the internal face which delimits the compartment LR of reflector RL.

In the non-limiting example illustrated in FIG. 4, the device comprises three light guides GL (here of slightly different form). Consequently, its reflector RL comprises three compartments LR suitable respectively for these three light guides GL.

It is understood that each compartment LR has a form similar to that of light guide GL that will be partially housed in it.

The reflecting character of the internal face of reflector RL can come from a metallization (at least of each compartment LR that it contains).

Such a reflector RL, can be constructed, for instance, by moulding in synthetic material, for instance, in PC (polycarbonate) or in PMMA or PPTD40.

The screen EC has at least one central part PC which is transparent and is intended to be placed opposite a part at least of the front part PV of a light guide GL in order to be illuminated by the light that it transfers towards the exterior and in this way inducing a style or three dimensional effect.

By “three dimensional effect” (or 3D) is understood here a volume effect that gives an observer the impression of mass and/or thickness (or depth) and/or a full-bodied character at least when the device D functions.

In the non-limiting examples illustrated in FIGS. 1 to 4, the screen EC has as many parts with concave section as there are light guides GL. In the non-limiting example of FIGS. 1 to 3, the screen EC comprises only one part with concave section, while in the non-limiting example of FIG. 4, it comprises three. It is understood that each part with concave section defines a compartment with shape similar to that of a light guide GL which it must partially house, in the general direction of extension of this light guide GL.

Each part of screen EC with concave section is defined by a central part PC and two lateral parts PL which are situated on both sides of this central part PC. It is clear that each compartment of screen EC is intended to house at least partially the front part PV of the corresponding light guide GL.

This compartment does not necessarily imply that the external face of the front part PV of each light guide GL is partially or totally in contact with the internal face that delimits a compartment of screen EC. Indeed, it can be envisaged that a light guide GL is at a slight distance from the internal face which delimits a compartment of screen EC.

To be noted that the two lateral parts PL of each part of screen EC with concave section are intended to reinforce the three dimensional effect and/or the style effect offered by device D (at least when it works). In particular, they give the impression that the corresponding light guide GL is larger than it is in reality, without however having a need to use more LEDs (which offers a real cost advantage).

It is important to note that each central part PC is a part towards which the light is directed in privileged manner thanks to the arrangement of reflector RL and the corresponding light guide GL. Therefore it provides strong illumination compared to that of the associated lateral parts PL.

In order to reinforce even more the three dimensional effect and/or the style effect, the lateral parts PL can be either transparent and grooved, or transparent and grained, or transparent and sanded, or transparent and polished, or metalized. Sanding allows more in particular for inducing a volume effect (reinforcement of width and thickness) when the device D functions. The metallization allows in particular to confer a volume effect when the device D does not function.

In variant or complement, each central part PC can be grooved, or grained, or sanded, or polished. Sanding in particular allows for masking a light guide GL and inducing a volume effect (reinforcement of width and thickness) when the device D functions.

Each zone which separates two parts of screen EC with adjacent concave section can if necessary be metalized.

To be noted, as illustrated in non-limiting manner in FIG. 2, that the screen EC can have a section of which the form varies between its two opposite extremities (respectively adjacent of extremities E1 and E2 of the light guides GL). For instance, and as illustrated in non-limiting manner, this section of screen EC can have a flaring which increases starting from the extremity which is situated near the first extremity E1 of a light guide GL. But, increasing flared sections and decreasing flared sections can coexist.

Screen EC can for instance be constructed by moulding in synthetic material, for instance PC (polycarbonate) or in PMMA or in APEC (in particular when it is situated in a zone that can thermally heat). Screen EC can if necessary be colored in the mass.

When the device D is part of an optical block, its screen EC is intended to be placed upstream of the glass of this optical block (in other words on the inside).

The invention is not limited to the implementation modes of the lighting device and the optical block described above, only as examples, but it encompasses all the variants that a person skilled in the art can envisage in the context of the following claims.

1.-15. (canceled)

16. A lighting device, said device comprising:
at least one light guide including two opposite extremities of which at least one is coupled to a light source;
a reflector having at least one concave section disposed opposite a rear part of each light guide to reflect guided light emitted from the light source toward a front part of the light guide; and
a screen having at least one transparent central part disposed opposite at least a portion the front part of each light guide such that the screen will be illuminated by the light from the respective light guide and induce at least one of a style and a three dimensional effect.

17. The device according to claim 1, wherein the rear part of each light guide is housed in a compartment provide by a zone of the concave portion of the reflector.

18. The device according to claim 2, wherein each central part of the screen is one of grooved, grained, sanded and polished.

19. The device according to claim 3, wherein the screen includes at lease one concave section defined by the central part and two lateral parts situated on opposing sides of each central part, whereby each concave section reinforces the at least one of the three dimensional effect and the style effect.

20. The device according to claim 4, wherein the lateral parts are one of:
transparent and grooved,
transparent and grained,
transparent and sanded,
transparent and polished, and
metalized.

21. The Device according to claim 5, wherein the screen has a section with a variable form between its two opposite extremities.

22. The device according to claim 6, wherein the section of the screen has an increasingly flared form.

23. The device according to claim 7, wherein the rear part of each light guide comprises a flat portion.

24. The device according to claim 8, wherein each flat portion includes a relief structured and operable to reflect the light towards the front part of the light guide.

25. The device according to claim 9, wherein each relief comprises grooves parallel to each other and perpendicular to the general direction of the light guide.

26. The device according to claim 10, wherein the grooves have a triangular section.

27. The device according to claim 11, wherein the light source comprises at least one light emitting diode.

28. The device according to claim 12, wherein the reflector comprises at least two concave sections placed opposite rear parts of a respective light guide, and in the screen comprises at least two central parts placed opposite the front parts of the respective light guides.

29. An optical block, said optical block comprising:
a lighting device, said device comprising:
at least one light guide including two opposite extremities of which at least one is coupled to a light source;
a reflector having at least one concave section disposed opposite a rear part of each light guide to reflect guided light emitted from the light source toward a front part of the light guide; and
a screen having at least one transparent central part disposed opposite at least a portion the front part of each light guide such that the screen will be illuminated by the light from the respective light guide and induce at least one of a style and a three dimensional effect.

30. A vehicle, said vehicle comprising:
an optical block, said optical block comprising:
a lighting device, said device comprising:
at least one light guide including two opposite extremities of which at least one is coupled to a light source;
a reflector having at least one concave section disposed opposite a rear part of each light guide to reflect guided light emitted from the light source toward a front part of the light guide; and
a screen having at least one transparent central part disposed opposite at least a portion the front part of each light guide such that the screen will be illuminated by the light from the respective light guide and induce at least one of a style and a three dimensional effect.
